(19) United States
(12) Patent Application Publication
(10) Pub. No.: US 2023/0019043 A1
(43) Pub. Date: Jan. 19, 2023

(54) LASER IRRADIATION STATE DIAGNOSIS METHOD, LASER IRRADIATION STATE DIAGNOSIS PROGRAM, LASER IRRADIATION STATE DIAGNOSIS DEVICE, AND LASER IRRADIATION DEVICE

(71) Applicant: TOYOKOH CO.,LTD., Fuji-shi, Shizuoka (JP)

(72) Inventors: Kenjiro MOMI, Fuji-shi, Shizuoka (JP); Kazuhisa FUJITA, Hamamatsu-shi, Shizuoka (JP); Manabu HARAGUCHI, Fuji-shi, Shizuoka (JP); Daisuke MORI, Fuji-shi, Shizuoka (JP); Momo TOSUE, Fuji-shi, Shizuoka (JP)

(21) Appl. No.: 17/780,278

(22) PCT Filed: Nov. 26, 2020
(86) PCT No.: PCT/JP2020/043918

§ 371 Date: May 26, 2022

(30) Foreign Application Priority Data
Nov. 29, 2019 (JP) 2019-216905

(51) Int. Cl. G01N 21/17; H04R 1/08; H04R 1/40; H04R 3/00

(52) U.S. Cl. CPC G01N 21/1702; H04R 1/08; H04R 1/406; H04R 3/005; G01N 2201/02; G01N 2201/06113

(57) ABSTRACT

Disclosed is a laser irradiation state diagnosing method which allows accurately diagnosing a laser irradiation state. When irradiating a laser beam so that an irradiation spot scans the surface of the irradiation object, acoustic information in vicinity of the irradiation spot is acquired. And based on characteristics of the acoustic information, such as an intensity of a component of a specific frequency band or a frequency band distribution, a state of peeling of the adhered substances existing on the surface of the irradiation object is determined.

### CROSS-REFERENCE RELATED TO PRIOR APPLICATIONS

This application is the U.S. national phase of International Application No. PCT/JP2020/043918 filed Nov. 26, 2020 which designated the U.S. and claims priority to JP 2019-216905 filed Nov. 29, 2019, the entire contents of each of which are hereby incorporated by reference.

### BACKGROUND OF THE INVENTION

### Field of the Invention

The present invention relates to a method of diagnosing an irradiation state of an irradiation object, a program, an apparatus and a laser irradiation apparatus having a function of diagnosing an irradiation state.

### Description of the Related Art

As a prior art related to a surface treatment using a laser beam, for example in Patent Document 1, it is described that, on an irradiation head which irradiates a laser beam to an irradiation object, a wedge prism which deflects a laser beam by a predetermined deflection angle is provided, and a laser beam is irradiated while the wedge prism is rotated. And an irradiation spot scans a surface of an irradiation object while turning, and an old paint coating, a foreign matter or the like adhering to the surface of the irradiation object is removed (cleaned).

In addition, in Patent Document 2, a laser processing apparatus for performing piercing processing is disclosed. It is described that a processing sound generated by supplying a processing gas is detected by a microphone provided in the vicinity, and a piercing completion is determined by utilizing a difference in frequency characteristics depending on whether or not a hole penetrates.

### PRIOR ART REFERENCE

### Patent Document

[Patent document 1] JP 2002-89033A

[Patent document 2] JP H 6-277862A

### SUMMARY OF THE INVENTION

In so-called laser cleaning described in Patent Document 1, in which an adhered substances on a surface of an irradiation object are peeled off by irradiating with a laser beam, confirmation of a degree of rust removal in rust removal from a steel structure for example, is performed principally by visual inspection.

However, visual confirmation depends on subjective judgment of an operator, and it is difficult to eliminate individual differences between operators.

Patent Document 2 describes that a result of piercing processing is detected based on a change in processing sound caused by a processing gas during penetration of a hole in a piercing (hole opening) process. This technique cannot be applied to a laser beam cleaning and the like in which there is no significant change in shape such as opening of a through hole in an irradiation object itself.

In view of the above problems, it is an object of the present invention to provide a laser irradiation state diagnosis method, a laser irradiation state diagnosis program, a laser irradiation state diagnosis apparatus, and a laser irradiation apparatus capable of accurately diagnosing an irradiation state of a laser.

The present invention solves the above problems by following solutions.

According to a 1st aspect of the present invention, there is provided a laser irradiation state diagnosis method, wherein, when irradiating a laser beam so that an irradiation spot scans the surface of the irradiation object, acoustic information in vicinity of the irradiation spot is acquired, and based on characteristics of the acoustic information, a state of peeling of adhered substances existing on the surface of the irradiation object is determined.

According to this method, based on the characteristics of the sound generated when the adhered substances are peeled off from the surface of the irradiation object, it is possible to determine the peeling state such as the peeled amount of the adhered substances caused by the irradiation of the laser beam. And the peeled state is accurately determined, for example, when the peeling treatment is finished and the peeling does not occur anymore.

Such a diagnosis can be performed in real time at a work site, and can be immediately reflected on the processing condition. Further, it is also possible to perform an analysis at a laboratory or the like using the recorded acoustic information. (Other similar diagnoses will be described later.)

According to a 2nd aspect of the present invention, there is provided a laser irradiation state diagnosis method according to 1st aspect, wherein the state of peeling is determined based on an intensity of a component of a specific frequency band in the acoustic information.

According to a 3rd aspect of the present invention, in the laser irradiation state diagnosis method according to 2nd aspect, the specific frequency band includes a frequency of a sound generated when the adhered substances are crushed by heat input from the laser beam.

According to a 4th aspect of the present invention, there is provided a laser irradiation state diagnosis method according to 1st aspect, wherein the state of peeling is determined based on characteristics of a frequency band distribution in the acoustic information.

According to each of these inventions, it is possible to reliably obtain the above-described effect.

According to a 5th aspect of the present invention, there is provided a laser irradiation state diagnosis method according to any one of 1st to 4th aspects, wherein a focus state of the laser beam is determined based on characteristics of the sound information.

According to a 6th aspect of the present invention, there is provided a laser irradiation state diagnosis method, wherein when irradiating a laser beam so that an irradiation spot scans a surface of the irradiation object, acoustic information near an irradiation spot is acquired, and a focus state of the laser beam is determined based on characteristics of the sound information.

In the focus state, the focus position of the laser beam is close to the surface of the irradiation object, and in the defocus state, the focus position is relatively apart from the surface of the irradiation object compared to the focus state. Due to changes in the state of peeling of adhered substances from the surface of an irradiation object, characteristics such as sound pressure and frequency of sound generated by peeling of the adhered substances change.

According to these aspects of the invention, it is possible to determine the focus state and the defocus state based on the characteristics of the acquired sound information.

According to a 7th aspect of the present invention, there is provided a laser irradiation state diagnosis method according to 5th or 6th aspect, wherein the acoustic information is compared with reference acoustic information obtained in a state in which the focal position of the laser beam is close to the surface of the irradiation object, and the focus state is determined.

According to a 8th aspect of the present invention, there is provided a laser irradiation state diagnosis method according to 5th or 6th aspect, wherein the focus state is determined based on an intensity of a component of a specific frequency band in the acoustic information.

According to each of these inventions, it is possible to appropriately extract the characteristics of the acoustic information corresponding to the focus state.

According to a 9th aspect of the present invention, there is provided a laser irradiation state diagnosis method according to any one of 5th to 8th aspects, wherein the focus state is determined based on a change in the acoustic information when the focus position of the laser beam is displaced relative to the irradiation object.

According to this method, it is possible to reliably detect the position of the irradiation head which can obtain the focus state, and to ensure the processing quality.

According to a 10th aspect of the present invention, there is provided a laser irradiation state diagnosis method according to any one of the 1st to 9th aspects, wherein the laser beam is relatively displaced to the irradiation object so that the irradiation spot scans the surface of the irradiation object along a predetermined pattern, wherein an inclination state of an irradiation head relative to an irradiation object is determined based on a periodic change of the acoustic information.

According to a 11th aspect of the present invention, there is provided a laser irradiation state diagnosis method, wherein when a laser beam is irradiated so that an irradiation spot scans a surface of an irradiation object along a predetermined pattern, acoustic information near an irradiation point is acquired, and an inclination state of the irradiation head relative to an object is determined based on a periodic (cyclic) change in the acoustic information.

In the case where the irradiation head for emitting the laser beam is inclined with respect to the irradiation object, and when the irradiation position of the irradiation object is scanned along a predetermined pattern, the focus state is changed according to the position of the irradiation spot on the pattern. Accordingly periodic change in sound information having the same period as a scanning period (for example, a period of turning when the irradiation portion turns, or in the case of reciprocating by a Galvano scanner etc., a periodic change of reciprocation) occurs.

According to the present invention, by determining the inclination of the irradiation head based on the periodic change of the acoustic information, it is possible to appropriately detect the inclination of the irradiation head with a simple configuration without providing a dedicated sensor for detecting the position and the attitude of the irradiation head.

According to a 12th aspect of the present invention, there is provided a laser irradiation state diagnosis method according to any one of 1st to 11th aspects, wherein the acoustic information is acquired while changing the irradiation condition of the laser beam at a predetermined period, and a signal synchronized with the period is extracted.

According to this, it is possible to extract only the signal synchronized with a predetermined period, to improve the quality of the signal such as improving the S/N ratio, and to accurately diagnose the laser irradiation state.

According to a 13th aspect of the present invention, there is provided a laser irradiation state diagnosis program which causes a computer including an acoustic information acquisition unit for acquiring acoustic information to execute the laser irradiation state diagnosis method described in any one of aspects 1th to 12th.

According to this, it is possible to obtain the same effect as the effect of the invention of each of the above laser irradiation state diagnosis methods.

In this Specification, Claim, etc., a computer includes, in addition to the so-called ordinary laptop computer and a desktop computer, those incorporated into a part of an irradiation apparatus such as an irradiation head or an operating panel, or those incorporated in a portable terminal apparatus such as a tablet, a smartphone and the like. For example, the program of the present invention can be used as an application program which is provided to a general-purpose portable terminal device by downloading or the like.

According to a 14th aspect of the present invention, there is provided a laser irradiation state diagnosis apparatus comprising an acoustic information acquisition unit for acquiring acoustic information in the vicinity of an irradiation spot when irradiating a laser beam so that the irradiation spot scans a surface of the irradiation object, and a peeling state determination unit which determines a peeling state of adhered substances existing on a surface of the irradiation object based on characteristics of the sound information.

According to a 15th aspect of the present invention, there is provided a laser irradiation state diagnosis apparatus according to 14th aspect, comprising a peeling state determination unit that determines the peeling state based on an intensity of a component of a specific frequency band in the acoustic signal.

According to a 16th aspect of the present invention, there is provided a laser irradiation state diagnosis apparatus according to 15th aspect, wherein the specific frequency band includes a frequency of sound generated when the adhered substance are crushed by heat input from the laser beam.

According to a 17th aspect of the present invention, there is provided a laser irradiation state diagnosis apparatus according to the 14th aspect, wherein the peeling state determination unit determines the peeling state based on characteristics of a frequency band distribution in the acoustic information.

According to each of these inventions, it is possible to obtain an effect similar to that of the invention according to any of above mentioned aspects 1th to 4th.

According to a 18th aspect of the present invention, there is provided a laser irradiation state diagnosis apparatus according to any one of 14th to 17th aspects, further comprising an informing unit which notifies a user when the peeling state determination unit determines that the peeling state of the adhered substances is settled.

According to this configuration, it is possible to notify a user of the completion of the peeling process of the adhered substances on the surface of the irradiation object, and to prompt an appropriate treatment. Here, in the present specification and the claims, the term “settling of peeling state” refers to a state in which the amount of substances peeled from an irradiation object is reduced.

According to a 19th aspect of the present invention, there is provided a laser irradiation state diagnosis apparatus according to any one of 14 to 18 aspects, further comprising a focus state determination unit that determines a focus state of the laser beam based on characteristics of the acoustic information.

According to a 20th aspect of the present invention, there is provided a laser irradiation state diagnosis apparatus comprising an acoustic information acquisition unit for acquiring acoustic information in the vicinity of an irradiation spot when irradiating a laser beam so that the irradiation spot scans a surface of the irradiation object, and a focus state determination unit for determining a focus state of the laser beam based on characteristics of the sound information.

According to a 21st aspect of the present invention, there is provided a laser irradiation state diagnosis apparatus according to 19th or 20th aspect, the focus state determination unit determines a focus state of the laser beam by comparing with a reference acoustic information acquired in a state in which the focus position of the laser beam is close to the surface of the irradiation object.

According to a 22nd aspect of the present invention, in the laser irradiation state diagnosis apparatus according to 19th or 20th aspect, the focus state determination unit determines the focus state based on an intensity of a component of a specific frequency band in the sound information.

According to a 23rd aspect of the present invention, there is provided a laser irradiation state diagnosis apparatus according to any one of 19th to 22th aspects, wherein the focus state determination unit determines the focus state based on a change in the acoustic information when the focus position of the laser beam is displaced relative to the irradiation object.

According to each of these inventions, it is possible to obtain the same effect as in the 5th to 9th aspects.

According to a 24th aspect of the present invention, there is provided a laser irradiation state diagnosis apparatus according to any one of 19th to 23th aspects, further comprising an informing unit that notifies a user when the focus state determination unit determines a defocus state.

According to this, it is possible to enhance the processing quality by quickly prompting the user toward correction when a defocus state occurs.

According to a 25th aspect of the present invention, there is provided a laser irradiation state diagnosis apparatus according to any one of 14th to 24th aspects, wherein the laser beam is relatively displaced to the irradiation object so that the irradiation spot scans the surface of the irradiation object along a predetermined pattern, further comprising an inclination state determination unit that determines an inclination state of an irradiation head with respect to the irradiation object based on a periodic change of the sound information.

According to a 26th aspect of the present invention, there is provided a laser irradiation state diagnostic device comprising an acoustic information acquisition unit for acquiring acoustic information in the vicinity of an irradiation spot when a surface of an irradiation object is irradiated with a laser beam so that an irradiation spot scans along a predetermined pattern, and an inclination state discrimination part which discriminates an inclination state of an irradiation head to an irradiation object based on a periodic change of the sound information.

According to these inventions, it is possible to obtain an effect similar to that of the invention according to aspects 10th and 11th.

According to a 27th aspect of the present invention, there is provided a laser irradiation state diagnosis apparatus according to any one of 14th to 26th aspects, wherein the acoustic information acquisition unit acquires the acoustic information while changing the irradiation condition of the laser beam at a predetermined period, and extracts a signal synchronized with the period.

According to this, it is possible to obtain the same effect as in the invention according to aspect 12th.

According to a 28th aspect of the present invention, there is provided a laser irradiation state diagnosis apparatus according to any one of 14th to 27th aspects, wherein the sound information acquisition unit includes a sound collection device provided in an irradiation head that emits the laser beam.

According to this configuration, by providing the sound collecting device on the irradiation head, handling such as installation and removal of the sound collecting device provided separately from the irradiation head becomes unnecessary, and the process can be simplified.

In addition, it is possible to reliably hold the sound collection device in a state of being directed to the vicinity of the irradiation spot.

According to a 29th aspect of the present invention, there is provided a laser irradiation state diagnosis apparatus according to 28th aspect, wherein a plurality of sound collection devices are provided, and the sound information acquisition unit generates a sound information based on outputs of the plurality of sound collection devices.

According to this configuration, by processing the outputs of the plurality of sound collecting devices to generate sound information, it is possible to improve the quality of the signal and to improve the accuracy of diagnosis of the irradiation state. For example, by using an average of outputs of the sound collecting devices, directivity toward the vicinity of the irradiation point can be enhanced.

According to a 30th aspect of the present invention, there is provided a laser irradiation state diagnosis apparatus according to any one of 14th to 27th aspects, wherein the sound information acquisition unit includes a sound collection device that is disposed at a position spaced apart from the irradiation head.

According to this configuration, sound-collecting device is less affected by the influence of the noise which the irradiation head itself generates from driving devices (for example, actuators such as a motor, a bearing, etc.) etc. and the diagnostic accuracy of irradiation conditions can be improved.

According to a 31st aspect of the present invention, there is provided a laser irradiation state diagnosis apparatus according to any one of 14th to 27th aspects, wherein the sound information acquisition unit includes a sound collection device attached to the irradiation object.

According to this configuration, by acquiring the acoustic information by the solid propagation from the irradiation object, it is not likely for the device to receive the influence of noise or the like in the surrounding environment, and it is possible to improve the accuracy of diagnosis of the irradiation condition.

According to a 32nd aspect of the present invention, there is provided a laser irradiation apparatus comprising an irradiation head which emits a laser beam so that an irradiation spot scans a surface of an irradiation object, and a laser irradiation state diagnosis apparatus according to any one of aspects 14th to 31th.

According to this, it is possible to obtain the same effect as in each of the inventions of aspects 14th to 31th.

According to a 33^{rd} aspect of the present invention, there is provided a laser irradiation apparatus according to 32th aspect, wherein the irradiation head includes a driving unit that drives a movable optical system that changes an optical path of the laser beam, and includes an abnormality determination unit that determines an abnormality of the driving unit based on the acoustic information.

According to this configuration, by using the acoustic information acquired by the sound collecting device, it is possible to determine both the laser irradiation state and the abnormality of the driving device with a simple configuration without providing a dedicated sensor or the like.

According to a 34^{th} aspect of the present invention, there is provided a laser irradiation apparatus according to 32th or 33th aspect, wherein the irradiation head includes a driving unit that drives a movable optical system that changes an optical path of the laser beam, and a speed detection unit that detects a driving speed of the driving unit based on the acoustic information.

According to this configuration, by using the acoustic information acquired by the sound collecting device, it is possible to determine both the laser irradiation state and the driving speed of the driving device with a simple configuration without providing a dedicated sensor or the like.

According to a 35^{th} aspect of the present invention, there is provided a laser irradiation apparatus according to any one of aspects 32th to 34^{th}, further comprising a sound recognition unit which recognizes a specific sound having predetermined characteristics from the acoustic information, and when the sound recognition unit recognizes the specific sound, the irradiation condition of the laser beam to be emitted is changed or the emission of the laser beam is stopped.

According to this configuration, it is possible to improve safety and convenience by stopping the emission in response to detection of a specific sound indicating that the emission of the laser beam should not be continued, in such as a dangerous state.

According to a 36^{th} aspect of the present invention, there is provided a laser irradiation apparatus according to 35^{th} aspect, wherein the specific sound is a sound generated by a sound generator disposed around an operator or outside of an irradiated area of an irradiation object.

For example, a sound generator, such as a speaker, a buzzer, or the like, which outputs a specific sound having a specific frequency, a sound generation pattern (such as an intermittent sound, a frequency change, or the like), is arranged around an operator (including the operator carrying the sound generator), so that it is possible to prevent an operator from erroneously irradiating the operator. Here, the operator is not limited to a person who operates an irradiation head but includes all persons existing in a work area.

Further, by arranging such a sound generating body around an irradiation object, it is possible to prevent an object other than an irradiation object from being erroneously irradiated to an object or the like. Further, by generating a specific sound, for example, by blowing a whistle by the operator, an emergency stop can be performed without directly operating the irradiation apparatus.

According to a 37^{th} aspect of the present invention, there is provided a laser irradiation apparatus according to 35^{th} aspect, wherein the specific sound is a voice of an operator.

According to this configuration, when the operator recognizes a word (e.g., “dangerous”) of an operator's shout for example, it is possible to urgently stop the irradiation apparatus.

According to a 38^{th} aspect of the present invention, there is provided a laser irradiation apparatus comprising an irradiation head which emits a laser beam so that an irradiation spot scans a surface of an irradiation object, and a laser irradiation state diagnosis apparatus according to any one of aspects 14^{th} to 18^{th}, wherein, when the peeling state determination unit determines that the peeling state of the adhered substances are settled, the emission condition of the laser beam is changed or the emission of the laser beam is stopped.

According to this configuration, the intensity of the laser beam is automatically reduced or the emission of the laser beam is stopped in response to the end of the peeling processing of the adhered substances on the surface of the irradiation object, thereby improving convenience and preventing damage to the irradiation object by excessive irradiation.

### Effect of the Invention

As described above, according to the present invention, it is possible to provide a laser irradiation state diagnosis method, a laser irradiation state diagnosis program, a laser irradiation state diagnosis apparatus, and a laser irradiation apparatus capable of accurately diagnosing an irradiation state of a laser.

### BRIEF DESCRIPTION OF THE DRAWINGS

FIG. 1 is a cross-sectional view of an irradiation head according to a first embodiment of a laser irradiation state diagnosis method and a laser irradiation apparatus to which the present invention is applied.

FIG. 2 is a block diagram schematically showing a system configuration of a laser irradiation apparatus according to a first embodiment.

FIG. 3 is a diagram showing an example of a frequency spectrum of acoustic information at the time of laser irradiation in the laser irradiation apparatus of the first embodiment.

FIG. 4 is a diagram showing an example of the intensity transition of sound information for each frequency band in the case of performing the rust removal work in the laser irradiation apparatus of the first embodiment.

FIG. 5 is a diagram showing an example of a spectrogram of acoustic information according to the focus and or defocus at the time of laser irradiation in the laser irradiation apparatus of the first embodiment.

FIG. 6 is a diagram showing an example of acoustic information expressed in a frequency domain at the time of inclination and non-inclination of an irradiation head in the laser irradiation apparatus according to the first embodiment.

### DESCRIPTION OF THE PREFERRED EMBODIMENTS

### The 1st Embodiment

Hereinafter, a laser irradiation state diagnosis method, a laser irradiation state diagnosis program, a laser irradiation state diagnosis apparatus, and a laser irradiation apparatus according to the 1st embodiment of the present invention will be described.

In the laser irradiation apparatus according to the 1st embodiment of the present invention for performing the laser irradiation state diagnosis method, there is provided an irradiation head 1 to which a beam of laser light supplied from a laser oscillator via a fiber is applied and the head irradiates the beam to the object O, and an irradiation point (beam spot BS) scans a surface of an irradiation object O along an arc scanning pattern, thus performing various cleaning processes such as removal of rust, peeling of an old paint coating and removal of adhered foreign substances. The irradiation object O is, for example, a metal structure of such as general steel, stainless steel, or an aluminum-based alloy, but is not particularly limited.

In the cleaning process, an irradiation spot (beam spot BS) is scanned on the surface of an irradiation object O by turning along a circular arc of a relatively large diameter of about 10 mm or more for example. By this laser processing (surface treatment), cleaning for various films such as rust, old paint coating (coating film to be peeled off), oxide film, and the like, and dust, soot etc. which have adhered to the surface of an irradiation object O are cleaned.

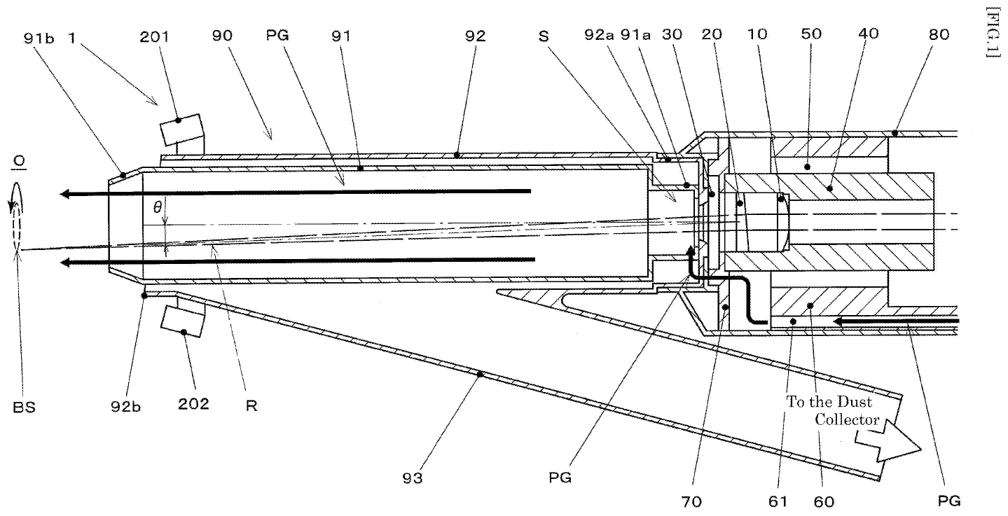

FIG. 1 is a cross-sectional view of an irradiation head in the laser irradiation apparatus according to the 1st embodiment.

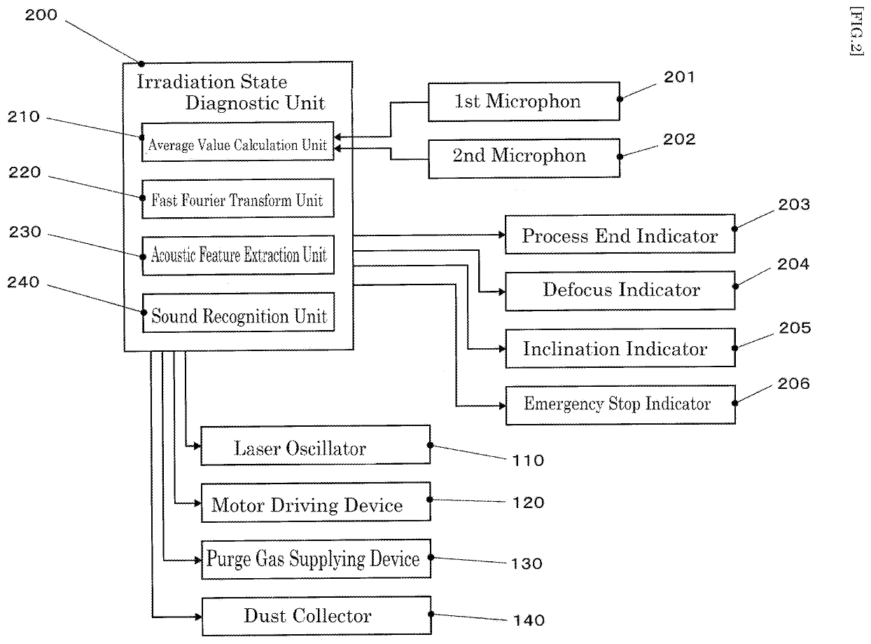

The irradiation head 1 irradiates a laser beam R of continuous wave (CW) transmitted from a laser oscillator 110 (see FIG. 2) through a fiber (not shown) onto an irradiation object O.

While the irradiation head 1 is, for example, of a handy type which allows an operator to carry out the work, it is also possible to use the irradiation head 1 by attaching it to a robot which can move the irradiation head 1 along a predetermined path.

The irradiation head 1 is provided with a focus lens 10, a wedge prism 20, a protective glass 30, a rotating cylinder 40, a motor 50, a motor holder 60, a protection glass holder 70, a housing 80, and a duct 90, etc.

The focus lens 10 is an optical element in which a laser beam R transmitted from a laser oscillator 110 via a fiber to an irradiation head 1 enters after passing through a collimator lens (not shown).

The collimator lens is an optical element that parallelizes (collimates) a laser beam emitted from an end of a fiber into a substantially parallel beam.

The focus lens 10 is an optical element which converges (focuses) a laser beam R emitted from a collimator lens at a predetermined focal position.

As the focus lens 10, for example, a convex lens having positive power can be used.

Note that the beam spot BS, which is an irradiation point on the surface of the irradiation object O by the laser beam R, is arranged in a close state in the vicinity of the focal point or within the depth of focus (focusing state) or a state separated from the focus position (defocus state) .

The depth of focus means a range in an optical axis direction in which the beam diameter is less than or equal to a diameter of a predetermined allowable circle of confusion.

The wedge prism 20 is an optical element which deflects the laser beam R emitted from the focus lens 10 by a predetermined deflection angle θ (see FIG. 1) and makes the optical axis angles of the incident side and the exit side different.

The wedge prism 20 is formed in a plate shape in which the thickness thereof is continuously changed so that one of the thicknesses in the direction perpendicular to the optical axis direction of the incident side becomes larger than the thickness of the other.

The protective glass 30 is an optical element made of a flat glass or the like which is disposed close to the wedge prism 20 in the focus position side (the irradiation object O side and the beam spot BS side) along the optical axis direction.

The protective glass 30 is a protective member which prevents foreign matter, such as a peeled material scattered from the irradiation object O side, spatters, dust, or the like, from adhering to other optical elements such as the wedge prism 20.

The protective glass 30 is an optical element disposed closest to the focal point position along the optical axis direction of the optical system of the irradiation head 1, and is exposed to the object O side through the space S and the duct 90 which are explained later.

The focus lens 10, the wedge prism 20, and the protective glass 30 are formed by coating a surface of a member made of a transparent material such as an optical glass, for example, with a coating for preventing reflection and surface protection.

The rotary cylinder 40 is a cylindrical member that holds the focus lens 10 and the wedge prism 20 on the inner diameter side.

The rotary cylinder 40 is formed concentrically with an optical axis of the focus lens 10 and an optical axis of the laser beam R (an optical axis of the collimator lens) which is incident on the focus lens 10.

The rotary cylinder 40 is rotatably supported by a bearing (not shown), with respect to the housing 80, around a rotation center axis coinciding with an optical axis of the focus lens 10.

The rotary cylinder 40 is made of a metal such as an aluminum alloy or an engineering plastic.

The motor 50 is an electric actuator which rotationally drives the rotary cylinder 40 around a rotation center axis with respect to the housing 80. For example, the motor 50 is configured as an annular motor that is concentric with the rotary cylinder 40 and is provided on an outer diameter side of the rotary cylinder 40.

A stator (not shown) of the motor 50 is fixed to the housing 80 via a motor holder 60.

A rotor (not shown) of the motor 50 is fixed to the rotary cylinder 40.

The motor 50 is controlled by a motor drive unit 120 (see FIG. 2) so that the rotational speed of the rotary cylinder 40 substantially coincides with a desired target rotational speed.

To maintain a posture of an irradiation head 1 so that a rotation center axis of a rotary cylinder 40 is orthogonal to a surface near an irradiation part of an irradiation object O, and the motor 50 rotates a wedge prism 20 together with a rotary cylinder 40. Thus the beam spot BS is circularly scanned along the surface of the irradiation object O in an arc shape around the rotation center axis of the rotary cylinder 40.

When the irradiation head 1 is moved translationally along the surface of the irradiation object O in this state, the beam spot BS scans the surface of the object O while rotating in an arc shape.

Thus, when attention is paid to an arbitrary point on the irradiation object O, the laser beam R is incident in a pulse form only for a short time, and rapid heating and rapid cooling are sequentially performed in a short time.

At this time, a cleaning object (adhered matter) such as an old painting film, rust, a coating film etc. formed on the surface of the irradiation object O, or an adhered foreign substances, are crushed and scattered.

The motor holder 60 is a support member that holds the stator of the motor 50 in a predetermined position inside the housing 80.

The main body of the motor holder 60 is formed in a cylindrical shape and is fixed to the housing 80 in a state of being inserted into the inner diameter side of the housing 80.

An inner peripheral surface of the motor holder 60 is disposed facing an outer peripheral surface of the motor 50 and is fixed to a stator of the motor 50.

A purge gas channel 61 through which a purge gas PG flows is formed in a portion between an outer peripheral surface and an inner peripheral surface of the motor holder 60.

The purge gas PG is a gas that is ejected from the space S in contact with the irradiation object O side surface of the protective glass 30, which will be described later, in the inner cylinder 91 of the duct 90 when the irradiation head 1 is used (during irradiation). A surface portion of the protective glass 30 on the irradiation object O side is disposed so as to be exposed inside the space portion S.

The purge gas PG has a function of preventing dust, such as an old paint coating, rust, or a fragment of a film, which scatters from the irradiation object O side, or foreign matter, such as sputtering, from flying into the housing 80 and adhering to the protective glass 30.

The purge gas channel 61 is an opening formed through a portion of the motor holder 60 in an axial direction of the motor 50.

The purge gas PG discharged from the purge gas channel 61 is introduced into the inner diameter side of the inner cylinder 91 of the duct 90 via a channel provided in the housing 80.

The protective glass holder 70 is a member fixed to the inner diameter side of the housing 80 while holding the protective glass 30.

The protective glass holder 70 is formed in a disk shape, for example, in which a circular opening is formed in a central portion.

The laser beam R passes through an aperture from the wedge prism 20 side toward the irradiation object O side.

A recessed portion into which a protective glass 30 is fitted is formed on a surface portion of the protective glass holder 70 on the irradiation object O side.

The protective glass 30 is held inside the housing 80 in a state in which it is fitted into this recess.

The protective glass 30 is detachably attached to the protective glass holder 70 so as to be replaceable when contamination or burnout occurs.

A surface portion of the protective glass holder 70 on the side opposite to the irradiation object O side is opposed to an end surface of the motor holder 60 on the irradiation object O side with a space.

This space constitutes a part of a flow path (a part of the fluid supply unit) which introduces the purge gas PG introduced from the purge gas flow path 61 of the motor holder 60 into the space S on the irradiation object O side of the protective glass 30.

The housing 80 is a cylindrical member constituting a casing of the main body of the irradiation head 1.

In the inside of the housing 80, the focus lens 10, the wedge prism 20, the protective glass 30, the rotary cylinder 40, the motor 50, the motor holder 60, the protection glass holder 70, etc. which were mentioned above are stored. Also, the end on the irradiation head 1 side of the fiber and the collimate lens, which is not illustrated, are stored.

The duct 90 is a double cylindrical member which is provided so as to protrude from an end portion of the housing 80 on the irradiation object O side.

The duct 90 includes an inner cylinder 91, an outer cylinder 92, a dust collector connecting cylinder 93 etc.

The motor holder 60, the protective glass holder 70, and the housing 80 described above are made of a metal such as an aluminum alloy or an engineering plastic etc.

The inner cylinder 91 is formed in a cylindrical shape.

The laser beam R passes through the inner diameter side of the inner cylinder 91 and is emitted to the irradiation object O side.

At an end of the inner cylinder 91 on the side of the housing 80, a small diameter portion 91a is formed in a stepped shape with respect to the other portion.

A purge gas PG is introduced from the inside of the housing 80 into the space S inside the small diameter portion 91a.

At an end portion of the inner cylinder 91 on the irradiation object O side, there is formed a tapered portion 91b which is tapered so as to have a smaller diameter of the irradiation object O side.

The tapered portion 91b has a function of reducing the flow the purge gas PG and increasing the flow speed while allowing the passage of the laser beam R.

The outer cylinder 92 is a cylindrical member arranged concentrically with the inner cylinder 91 and is provided on an outer diameter side of the inner cylinder 91.

Between the inner peripheral surface of the outer cylinder 92 and the outer peripheral surface of the outer cylinder 91, a continuous gap is formed over the entire circumference.

At an end of the outer cylinder 92 on the side of the housing 80, a small diameter portion 92a formed in a stepped shape with respect to the other portion is formed.

The small diameter portion 92a is fixed in a state of being fitted in an end portion of the housing 80 on the side of the irradiation object O.

An edge of an end 92b of the outer cylinder 92 on the irradiation object O side is formed to be inclined with respect to a rotation center axis of rotation of the rotary cylinder 40, so that an upper side becomes a housing 80 side relative to the lower side, at the time of normal use of irradiation with the rotation center axis of the rotary cylinder 40 being horizontal.

The dust collector connecting tube 93 is a cylindrical tube body which protrudes from the outer cylinder 92 toward the outer diameter side and is connected in a state of communicating with the inner diameter side of the outer cylinder 92.

The dust collector connecting tube 93 is provided below the outer cylinder 92 during the aforementioned normal use.

The dust collector connecting tube 93 is disposed to be inclined with respect to the outer cylinder 92 so as to depart (separate) from the outer cylinder 92 as approaching to the housing 80 side from the irradiation object O side.

One end of the dust collector connecting tube 93 is connected to the outer cylinder 92 in the vicinity of an end of the outer cylinder 92 on the irradiation object O side so as to communicate with the inside of the outer cylinder 92.

The end of another side of the dust collector connection tube 93 is connected to the dust collector 140 (refer to FIG. 2), and vacuum suction is carried out so that an inside may serve as negative pressure.

In the 1st embodiment, while emitting the laser beam R, by rotating the rotating cylinder 40 and the wedge prism 20, the beam spot BS rotates on an arc of a predetermined radius along the surface of the irradiation object O.

In this state, by moving the irradiation head 1 parallel along the surface of the irradiation object O, it is possible to perform a cleaning process in which the beam spot BS scans the surface of the irradiation object O.

Further, in the 1st embodiment, an inert gas such as nitrogen gas, which also functions as a shield gas, can be used as the purge gas PG.

In this inert gas, a region including the beam spot BS and its turning radius (within the scanning pattern) is made into an atmosphere filled with nitrogen, and is blocked from oxygen.

FIG. 2 is a block diagram schematically showing a system configuration of the laser irradiation apparatus according to the 1st embodiment.

The laser irradiation device includes a laser oscillator 110, a motor driving device 120, a purge gas supplying device 130, a dust collecting device 140, an irradiation condition diagnosing part 200, and etc.

The laser oscillator 110 generates a laser beam which is irradiated as a laser beam R onto an irradiation object, and supplies the laser beam to an irradiation head 1 via a fiber.

As the laser oscillator 110, for example, a CW laser having an average power of about 1 kW can be used, but the present invention is not limited thereto as will be described later.

The motor driving device 120 is a power supply device that supplies driving electric power to the motor 50.

The motor driving device 120 has a function of adjusting a rotational speed of the motor 50.

A motor driving device 120 performs feedback control so that an actual rotation speed of a motor 50 detected by an irradiation condition diagnosing part 200 coincides with a predetermined target rotation speed.

In the 1st embodiment, a function of detecting the rotational speed of the motor 50 based on the acoustic information is provided. This will be described in detail later.

The purge gas supply unit 130 supplies a purge gas PG such as nitrogen gas to the purge gas flow path 61.

As the purge gas supply device 130, for example, a container in which a purge gas is stored in a compressed state or a nitrogen gas generator can be used.

The dust collecting device 140 collects a peeled substances or the like scattered from an irradiation object when the laser beam R is irradiated.

The dust collector 140 is connected to the dust collector connecting tube 93, and has a negative pressure generating source for sucking negative pressure, and a dust collecting means such as a cyclone for collecting the scattered matter.

The irradiation state diagnosis unit 200 acquires the acoustic information generated by the beam spot BS or the irradiation head 1 itself, and diagnoses the irradiation state of the beam spot BS and the state of the irradiation head 1 based on the acoustic information.

The irradiation state diagnosis unit 200 is configured as a computer including an information processing unit such as a CPU, a storage unit such as a RAM and a ROM, an input/output interface, and a bus connecting these components etc.

The irradiation state diagnosis unit 200 executes a laser irradiation state diagnosis program for performing the laser irradiation state diagnosis method of the 1st embodiment.

A 1st microphone 201, a 2nd microphone 202, a process end indicator 203, a defocus indicator 204, an inclination indicator 205, an emergency stop indicator 206 etc. are connected to the irradiation state diagnosis unit 200.

The 1st microphone 201 and the 2nd microphone 202 are sound collecting devices for acquiring acoustic information in the vicinity of the beam spot BS.

For example, a unidirectional microphone may be used as the 1st microphone 201 and the 2nd microphone 202.

As shown in FIG. 1, for example, the 1st microphone 201 and the 2nd microphone 202 are arranged in the vicinity of an end portion on the irradiation object side of the irradiation head 1 so as to be directed to the vicinity of the beam spot BS in a state of being separated toward a radial direction of the duct 90.

Thus, the acoustic information around the beam spot BS can be acquired with high sensitivity, and the sound generated by the irradiation head 1 can be acquired to a certain extent.

The process end indicator 203 is an informing means for indicating to the user that the peeling process has finished, when the irradiation condition diagnosing unit 200 determines that the peeling of the deposit does not occur substantially from the surface of the irradiation object.

The defocus indicator 204 is an informing means which indicates to the user that a defocus state is arising and indicates a method of moving the irradiation head 1 (i.e., a direction of moving away from the irradiation object or approaching thereto) for changing into a focus state, when the irradiation state diagnostic section 200 determines that the beam spot BS is in the defocus state in which the beam spot BS deviates from the depth of focus of the laser beam R.

The inclination indicator 205 is an informing means which indicates to the user that an inclined state has occurred and indicates an operation direction of an irradiation head 1 for eliminating an inclined state, when the irradiation condition diagnostic part 200 determines that the axial direction of the irradiation head 1 (the rotation center axis direction of the rotary cylinder 40) is inclined by a predetermined value or more relative to the normal-line direction of the surface of the irradiation object.

An emergency stop indicator 206 is an informing means for indicating to the user that the emergency stop is performed, when the irradiation condition diagnosis unit 200 detects that the laser beam R is irradiated in a state of being deviated from the irradiation object and the irradiation is urgently stopped.

Each of these indicators includes, for example, a warning lamp, an image display device, a sound output device, and the like.

The irradiation state diagnosis unit 200 includes an average calculation unit 210, a fast Fourier transform unit 220, an acoustic feature extraction unit 230, and a sound recognition unit 240.

The irradiation state diagnosis unit 200 has a function of an acoustic information acquisition unit, a peeling state determination unit, a focus state determination unit, an inclination state determination unit, an abnormality determination unit, a speed detection unit, and a sound recognition unit.

These functions will be described in detail later.

The average value calculation unit 210 calculates an average value of sound data collected by the 1st microphone 201 and the 2nd microphone 202, and transmits the average value to the fast Fourier transform unit 220. In the fast Fourier transform unit 220, to the acoustic information transmitted from the average value calculation unit 210, a known fast Fourier transform (FFT) process is performed and data is converted from the time domain into the frequency domain.

The acoustic feature extraction unit 230 extracts a component of a predetermined frequency band from the acoustic information of the frequency domain generated by the fast Fourier transform unit 220, and determines the irradiation state of the laser beam R at the beam spot BS based on intensity (amplitude) thereof and the like.

The sound recognition unit 240 recognizes a component having a predetermined characteristic (such as a specific sound described later) from the acoustic information.

Hereinafter, the function of the irradiation state diagnosis unit 200 will be described in detail.

### <Peeling State Determining Function>

The irradiation state diagnosis unit 200 has a function of determining whether or not adhered substances which are the object to be processed such as rust or an old paint coating, are crushed and peeled from on the surface of the irradiation object O, which is scanned by the beam spot BS of the laser beam R.

Conventionally, confirmation of the degree of rust removal in a rust-removing work using a laser has been performed principally by visual inspection.

However, visual confirmation depends on subjective judgment of an operator, and it is difficult to eliminate individual differences between operators.

Thus, for example, in JIS Z 2358, it is defined that the degree of rust removal is evaluated by a color sample or a color meter. However, this method is suitable for final evaluation after execution, but requires time for evaluation, so that it is difficult to immediately feed-back the measurement result to the execution condition.

In addition, during actual execution, it is difficult to determine in real time whether or not an appropriate execution state (such as whether or not an irradiation head is held at an appropriate distance and an angle to an irradiation object) is performed.

On the other hand, in the 1st embodiment, by discriminating the peeling state using the acoustic information, it is possible to diagnose the peeling state independent of the subjectivity of the operators . In addition, such a diagnosis can be made in real time and can be immediately fed back to the execution conditions.

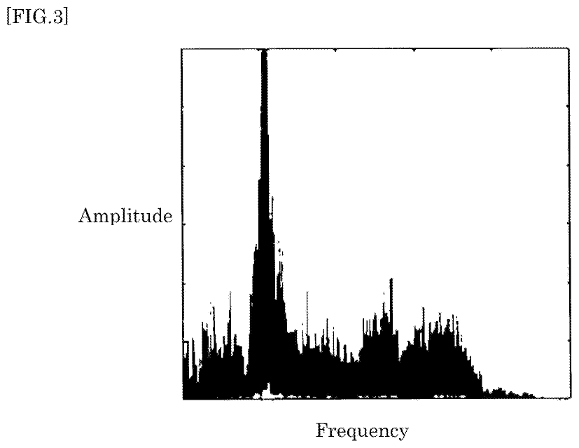

FIG. 3 is a diagram showing an example of a frequency spectrum of acoustic information at the time of laser irradiation in the laser irradiation apparatus according to the 1st embodiment.

In FIG. 3, a horizontal axis represents frequency, and a vertical axis represents amplitude (intensity and sound pressure).

The inventors of the present invention have found that in a cleaning process in which rust, which is an adhered substance on the surface of an irradiation object, is peeled off by irradiation with a laser beam R, the frequency distribution characteristic of acoustic information changes with the progress of the peeling process.

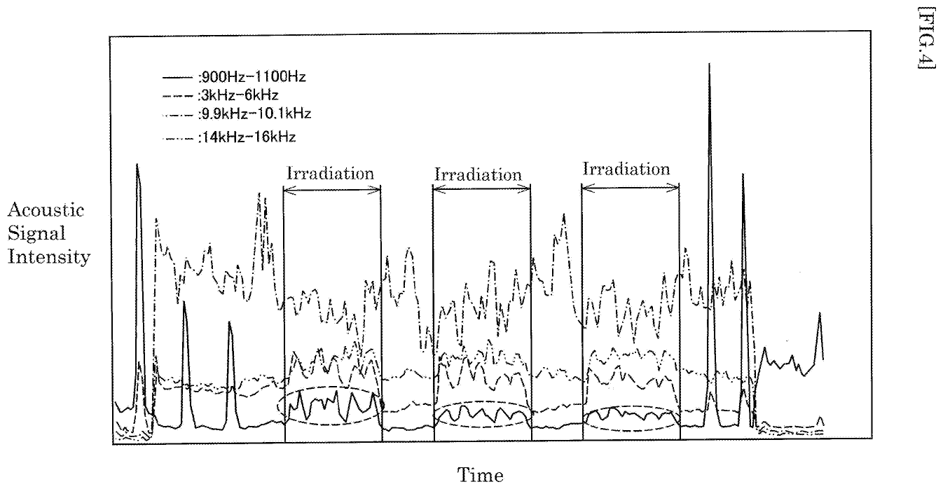

FIG. 4 is a diagram showing an example of the intensity transition of acoustic information for each frequency band when removing (cleaning) the rust in the laser irradiation apparatus of the 1st embodiment.

In FIG. 4, a horizontal axis represents time, and a vertical axis represents an average value of an acoustic signal intensity in a predetermined frequency band.

Data from 900 Hz to 1100 Hz is shown in a solid line.

Data from 3 kHz to 6 kHz are indicated by a dashed line (dotted line).

Data from 9.9 kHz to 10.1 kHz are shown by a 1 dot chain line.

Data from 14 kHz to 16 kHz is shown by a 2 dot chain line.

As shown in FIG. 4, in the band of 900 Hz to 1100 Hz indicated by a solid line, it can be seen that, when the irradiation processing is repeated, the intensity decreases sequentially.

It is considered that this frequency band includes sound generated when the rust adhering to the surface of an irradiation object is crushed by the rapid heat input and subsequent cooling when the beam spot BS passes during the scanning.

Therefore, based on the absolute value of the sound signal intensity of the specific frequency band or the decrease of the relative value relative to the other frequency band, it is determined whether or not the peeling state has been settled (peeled substances has reduced).

For example, when such an intensity becomes equal to or lower than a predetermined threshold value, the end of the peeling process is determined, the emission of the laser beam R is stopped, or the intensity is reduced, and the end of the peeling process is notified to the user by the process end indicator 203.

### <A Focus Judgment>

The irradiation state determination unit 200 has a function of determining whether the focus position of the laser beam R is in a focus state in which the focus position of the laser beam R substantially coincides with the surface of the irradiation object O or in a defocus state in which the focus position is apart from the surface of the irradiation object O based on the acoustic information.

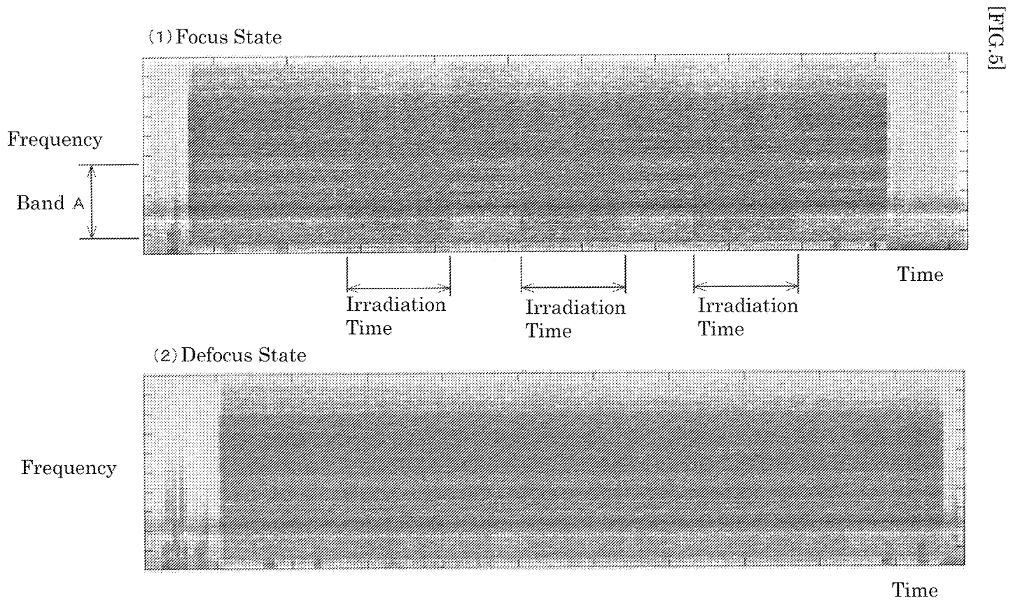

FIG. 5 is a diagram showing an example of a spectrogram according to the focus and defocus of acoustic information at the time of laser irradiation in the laser irradiation apparatus of the 1st embodiment.

In FIG. 5, a horizontal axis represents time, and a vertical axis represents frequency. Further, it is shown that the intensity of the acoustic signal is higher as the dark color becomes darker.

In FIG. 5, the upper portion shows data in a focus state, and the lower portion shows data in a defocus state.

FIG. 5 shows data when 3 irradiations are intermittently performed.

At this time, at the time of focusing shown in the upper stage, it is found that the signal intensity in the predetermined frequency band A is significantly larger at the irradiation time than at the non-irradiation time, but this phenomenon is not observed at the time of defocus.

Therefore, by comparing the intensity of such frequency band A with a preset threshold value, it is possible to determine the focus state.

Alternatively, a configuration may be adopted in which reference data (reference sound data) for the intensity of each of the audio signals at the time of focus is held in advance, and the defocus state is determined based on the deviation of the intensity distribution of the actually acquired sound data from the reference data.

### <Inclination Judging>

The irradiation state diagnosis unit 200 has a function of determining whether the rotation center axis of the wedge prism 20 in the irradiation head 1 is in a rightly facing state in which the rotation center axis coincides with a normal-line direction of the surface of the irradiation object, or in an inclined state in which the irradiation head 1 is inclined with respect thereto.

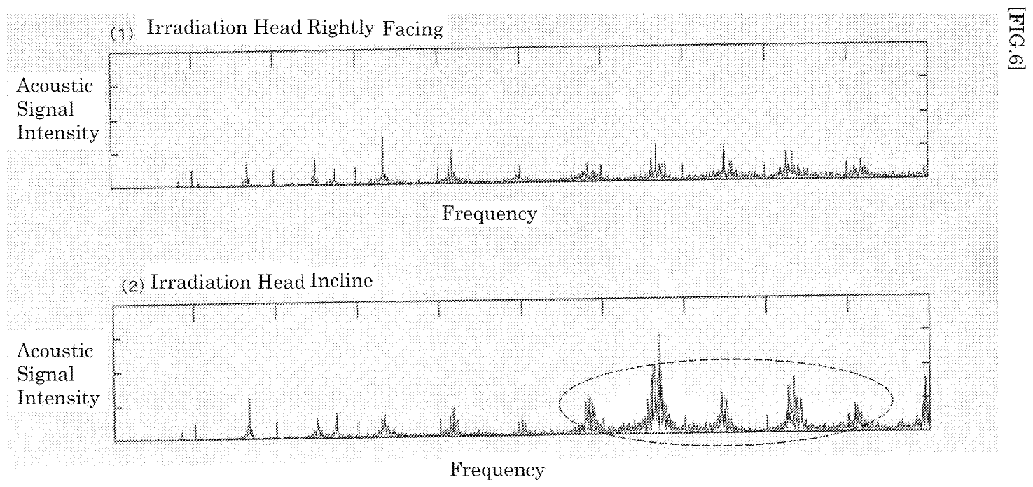

FIG. 6 is a diagram showing an example of acoustic information expressed in a frequency domain at the time of tilting and non-tilting of an irradiation head in the laser irradiation apparatus of the 1st embodiment.

In FIG. 6, a horizontal axis represents a frequency, and a vertical axis represents an intensity of acoustic information.

When the irradiation head 1 is in the rightly facing positive facing state (non-inclined state), the state of focus at the beam spot BS becomes constant regardless of the position at which the beam spot BS is rotated.

On the other hand, in the inclined state, the distance from the focus lens 10 varies depending on the position of the beam spot BS, so that the focus state and the defocus state change periodically. This variation period coincides with the rotation period of the wedge prism 20.

Therefore, in the inclined state, the intensity of the regular peak train, which appears in correlation with the rotation period of the wedge prism 20, increases with respect to the rightly facing state, as indicated by an ellipse indicated by a broken line in the drawing.

Based on an increase in intensity of such a peak, it is possible to determine an inclination state, and it is also possible to estimate a degree of inclination based on the intensity.

If the state of inclination is determined, the irradiation state diagnosis unit 200 activates the inclination indicator 205 and urges the operator to correct the posture of the irradiation head 1.

### <Motor Rotation Speed Judging>

The irradiation state diagnosis unit 200 has a function for detecting a rotation speed of the motor 50 (equal to the rotation speed of the wedge prism 20 and the rotation cylinder 40) based on a specific frequency component included in the sound information.

The acoustic information includes a component of a specific frequency band proportional to the rotational speed of the motor 50.

The irradiation state diagnosis unit 200 can detect the rotation speed of the motor 50 based on the transition of the frequency band caused by the motor 50.

The detected rotational speed can be used, for example, for controlling the rotational speed of the motor 50 by the motor drive device 120.

### <Motor, Bearing Abnormality Determination>

The irradiation state diagnosis unit 200 has a function of detecting an abnormality of the motor 50 and a bearing supporting the rotation cylinder 40 based on the acoustic information.

The irradiation state diagnosis unit 200 holds the sound information acquired when the motor 50 and the rotation cylinder 40 are normal as reference data. When there is a specific frequency band not included in the reference data and a component having an intensity equal to or higher than a predetermined value, it is determined that an acoustic signal related to this component is an abnormal sound due to the failure of the motor 50 and the bearing.

When an abnormal sound is detected, an irradiation state diagnosing unit 200 determines that some trouble has occurred in an irradiation head 1, and stops the emission of a laser beam R and the driving of a motor 50, and actuates an emergency stop indicator 206.

### <The Emergency Stop by Specific Sound>

When the irradiation condition diagnosing unit 200 recognizes a specific sound having characteristics set in advance in the sound information, it has a function of stopping the emission of the laser beam R or changing the irradiation condition such as lowering the intensity.

As a specific sound, for example, a sound generator such as a speaker, a buzzer, or the like that outputs a specific sound having a specific frequency, a sound generation pattern (e.g., an intermittent sound, a frequency change, or the like) is arranged around an operator (including an operator carrying the sound generator), thereby preventing the irradiation head 1 from being erroneously irradiated to an operator or the like. Here, the worker is not limited to a operator who operates the irradiation head 1, and includes all persons existing in the work area.

Further, by arranging such a sound generating body around the irradiation object O, it is possible to recognize that the light emitting body is close to the sound generating body or that the irradiation head 1 is directed, and thus it is possible to prevent an object other than the irradiation object O from being erroneously irradiated.

Further, by generating a specific sound by an active behavior such as blowing a whistle by an operator, an emergency stop can be performed without operating the direct irradiation device.

Further, the specific sound may be a voice of an operator.

For example, a configuration may be adopted in which the irradiation apparatus is urgently stopped when the user has recognized a word (e.g., “dangerous”) indicating a shout or a risk.

According to the 1st embodiment described above, the following effects can be obtained.
(1) Based on the characteristics of the sound generated when the adhered substances such as rust is peeled off from the surface of the irradiation object O, the peeling state such as the peeling amount of the adhered substances by the irradiation of the laser beam R is discriminated, and when the peeling process is finished, it is possible to accurately determine this state in real time.
(2) In a focus state in which the focal position of the laser beam R is close to the surface of the irradiation object O, and, in a defocus state in which the focus position is relatively spaced from the surface of the irradiation object O compared to the focus state, the peeling state such as rust on the surface of the irradiation object changes, and thus, the characteristics such as the sound pressure and the frequency of the sound generated by the peeling of the rust or the like change.

Using this characteristics, it is possible to determine the focus state and the defocus state based on the intensity of the specific frequency band A.

(3) If the irradiation head 1 inclines to the irradiation object O when beam-spot BS rotates in a circle and scans the surface of the irradiation object O, responding to the position of beam-spot BS on a circle, a change in the focus state results in a periodic sound change having the same period as the rotation period.

According to the 1st embodiment, by determining the inclination state of the irradiation head 1 based on the periodic change of the acoustic information (the peak of a specific frequency), it is possible to appropriately detect the inclination of the irradiation head 1 with a simple configuration without providing a position sensor, an acceleration sensor, or the like for detecting, for example, the position and the posture of the irradiation head 1.

(4) By providing the 1st and 2nd microphones 201,202 on the irradiation head 1, it is unnecessary to install and remove the sound collecting device provided separately from the irradiation head 1, and the process can be simplified.

Further, each microphone 201,202 can be held in a state of being directed to the vicinity of the beam spot BS reliably.

(5) By processing the output of the plurality of microphones 201,202 to generate acoustic information, it is possible to improve the quality of the signal and to improve the diagnostic accuracy of the irradiation state. Specifically, by using an average of outputs of the microphones 201,202, directivity toward the vicinity of the beam spot BS can be enhanced.

(6) By using the acoustic information acquired by each microphone 201,202, it is possible to discriminate the rotational speed and abnormality of the drive unit such as the motor 50 etc., together with the laser irradiation state, without using any other dedicated sensor or the like.

(7) It is possible to improve the safety and convenience by stopping the emission of the laser beam in response to the detection of the specific sound indicating that the emission of the laser beam should not be continued, in such as a dangerous state.

### The 2nd Embodiment

Next, a laser irradiation state diagnosis method, a laser irradiation state diagnosis program, a laser irradiation state diagnosis apparatus, and a laser irradiation apparatus according to the 2nd embodiment of the present invention will be described.

In each of the embodiments described below, portions substantially common to the previous embodiments will be denoted by the same reference numerals, and description thereof will be omitted, and mainly differences will be described.

In the 2nd embodiment, instead of the 1st microphone 201 and the 2nd microphone 202 provided in the irradiation head 1 in the 1st embodiment, a sound collecting device (a microphone) is provided independently from the irradiation head 1 is provided in proximity to the irradiation object to obtain acoustic information.

According to the 2nd embodiment described above, in addition to the effects similar to those of the 1st embodiment described above (except for those described in the paragraph (4)), noise generated in the acoustic information in the motor and the like is hardly included in the acoustic information, and diagnosis of the irradiation state can be performed more accurately.

### The 3rd Embodiment

Next, a laser irradiation state diagnosis method, a laser irradiation state diagnosis program, a laser irradiation state diagnosis apparatus, and a laser irradiation apparatus according to the 3rd embodiment of the present invention will be described.

In the 3rd embodiment, instead of the 1st microphone 201 and the 2nd microphone 202 provided in the irradiation head 1 in the 1st embodiment, a sound collection device (an acoustic pickup) provided independently from the irradiation head 1 is attached to an irradiation object to obtain acoustic information.

In the 3rd embodiment described above, by obtaining the acoustic information by the solid propagation from the irradiation object, in addition to the effects similar to those of the 1st embodiment described above (except for those described in the paragraph (4)), the noise and the like of the surrounding environment are not easily picked up by the sound collecting device, accordingly it is possible to further improve the accuracy of the diagnosis of the irradiation state.

### The 4th Embodiment

Next, a laser irradiation state diagnosis method, a laser irradiation state diagnosis program, a laser irradiation state diagnosis apparatus, and a laser irradiation apparatus according to the 4th embodiment of the present invention will be described.

In the 4th embodiment, irradiation conditions of the irradiation head 1, by modulating at least one of the intensity of laser light (oscillator output), the rotation speed of the wedge prism and the focus position for example, in a period T, and by performing a noise elimination process called a lock-in amplifier, quality of sound (S/N) is improved.

The lock-in amplifier is a technique suitable for extracting a small repetitive signal from a signal including noise.

When the irradiation condition is modulated at a period T, if the acoustic signal or a function S (t) of a time t of a frequency spectrum is changed in a period T,

S(t)×sin (2πt/T), and, S(t)×cos (2πt/T).

is integrated in time, noise is canceled and only a signal synchronized with a period T is left, so that only signals resulting from irradiation of the laser beam R can be detected with high accuracy.

According to the 4th embodiment described above, it is possible to extract only the signal synchronized with a predetermined period, to improve the S/N ratio, and to diagnose the laser irradiation state with higher accuracy.

### The 5th Embodiment

Next, a laser irradiation state diagnosis method, a laser irradiation state diagnosis program, a laser irradiation state diagnosis apparatus, and a laser irradiation apparatus according to the 5th embodiment of the present invention will be described.

In the 5th embodiment, the irradiation head 1 has an autofocus mechanism for changing the position of the focus with respect to the irradiation head 1 by, for example, driving the focus lens 10 in the optical axis direction.

In the 5th embodiment, while the focus position relative to the irradiation object O in the optical axis direction of the focus lens 10 is continuously or intermittently changed by an autofocus mechanism, the aforementioned focus state is determined. Thus, an autofocus control is performed and the position of the focus lens 10 is automatically set so as to obtain a focus state.

According to the 5th embodiment described above, in addition to the effects similar to those of the 1st embodiment described above, it is possible to reliably detect the position of the irradiation head which can obtain the focus state and to ensure the processing quality.

### (Modification)

The present invention is not limited to the above described embodiments, and various modifications and changes can be made without departing from the scope of the present invention.

(1) The configuration of the laser irradiation state diagnosis method, the laser irradiation state diagnosis program, the laser irradiation state diagnosis apparatus, and the laser irradiation apparatus is not limited to the above-described embodiments. It can be modified as appropriate.

For example, the shapes, the structures, the materials, the manufacturing method, the arrangement, quantity and the like of the respective members constituting the laser irradiation state diagnosis apparatus, the laser irradiation apparatus, and the like can be appropriately changed.

In addition, even in the type of laser, such as a fiber laser, a YAG laser, and a CO₂ laser, and in an oscillation method such as the pulse laser and the QCW laser etc. can be appropriately selected.

(2) In the laser irradiation apparatus of each of the embodiments, the laser beam R is rotated by rotating the wedge prism, but the present invention is not limited thereto, and the irradiation position may be scanned along a predetermined pattern by another method.

For example, a galvanometer scanner may be used to scan an irradiation object. Also, the scanning pattern is not limited to circular rotation, and may be, for example, a turn along a polygonal trajectory or another pattern.

(3) The arrangement of the sound collecting device in the sound information acquiring unit shown in each embodiment is an example, and can be changed as appropriate.

For example, in the 1st embodiment, for example, a pair of microphones is used as a sound collecting device, however, the number of sound collecting devices used is not particularly limited and may be changed as appropriate.

(4) A method of calculating and determining an acoustic signal in each embodiment is an example, and can be changed as appropriate.

(5) Although each of the embodiments has been described as an example of removing rust (laser cleaning), the present invention can be applied to, for example, peeling of an old painting film and cleaning of foreign matters. Further, the determination of the focus state and the tilt state is applicable not only to laser cleaning but also to other applications such as substrate adjustment.

[Explanation of letters or numerals]

| | | | |
|---|---|---|---|
| 1 | irradiation head | 10 | focus lens |
| 20 | wedge prism | 30 | protective glass |
| 40 | rotary cylinder | 50 | motor |
| 60 | motor holder | 61 | purge gas passage |
| 70 | protection glass holder | 80 | housing |
| 90 | duct | 91 | inner cylinder |
| 91a | small diameter portion | 91b | tapered portion |
| 92 | outer cylinder | 92a | small diameter portion |
| 92b | end | 93 | dust collector |
| | | | connecting tube |
| 110 | laser oscillator | 120 | motor driving device |
| 130 | purge gas supplying device | | |
| 140 | dust collector | | |
| 200 | irradiation state | | |
| | diagnostic unit | | |
| 201 | 1st microphone | 202 | 2nd microphone |
| 203 | process end indicator | 204 | defocus indicator |
| 205 | inclination indicator | 206 | emergency stop indicator |
| 210 | average value | 220 | fast Fourier |
| | calculation unit | | transform unit |
| 230 | acoustic feature | 240 | sound recognition unit |
| | extraction unit | | |

1. A laser irradiation state diagnosis method, wherein
when irradiating a laser beam so that an irradiation spot scans the surface of the irradiation object, acoustic information in vicinity of the irradiation spot is acquired,
and based on characteristics of the acoustic information, a state of peeling of adhered substances existing on the surface of the irradiation object is determined, and wherein
the acoustic information is acquired while changing the irradiation condition of the laser beam at a predetermined period,
and a signal synchronized with the period is extracted.

2-10. (canceled)

11. A laser irradiation state diagnosis method, wherein
when a laser beam is irradiated so that an irradiation spot scans a surface of an irradiation object along a predetermined pattern, acoustic information near the irradiation spot is acquired,
and an inclination state of the irradiation head relative to the object is determined based on a periodic change in the acoustic information.

12. (canceled)

13. A laser irradiation state diagnosis program which causes a computer including an acoustic information acquisition unit for acquiring acoustic information to execute the laser irradiation state diagnosis method of claim 1.

14. A laser irradiation state diagnosis apparatus comprising:
an acoustic information acquisition unit for acquiring acoustic information in the vicinity of an irradiation spot when irradiating a laser beam so that the irradiation spot scans a surface of an irradiation object; and
a peeling state determining unit which determines a peeling state of adhered substances existing on a surface of the irradiation object based on characteristics of the sound information,
wherein the acoustic information acquisition unit acquires the acoustic information while changing the irradiation condition of the laser beam at a predetermined period, and extracts a signal synchronized with the period.

15-25. (canceled)

26. A laser irradiation state diagnosis apparatus comprising
an acoustic information acquisition unit for acquiring acoustic information in the vicinity of an irradiation spot when irradiating a laser beam so that the irradiation spot scans a surface of an irradiation object along a predetermined pattern,
and an inclination state determination unit which determines an inclination state of an irradiation head to an irradiation object based on a periodic change of the sound information.

27. (canceled)

28. A laser irradiation state diagnosis apparatus according to claim 14, wherein
the sound information acquisition unit includes a sound collection device provided in an irradiation head that emits the laser beam.

29. A laser irradiation state diagnosis apparatus according to claim 28, wherein
a plurality of sound collection devices are provided, and
the sound information acquisition unit generates the sound information based on outputs of the plurality of sound collection devices.

30. The laser irradiation state diagnosis apparatus according to claim 14, wherein the sound information acquisition unit includes a sound collection device that is disposed at a position spaced apart from the irradiation head.

31. The laser irradiation state diagnosis apparatus according to claim 14, wherein the sound information acquisition unit includes a sound collection device attached to the irradiation object.

32. A laser irradiation apparatus comprising:
an irradiation head which emits a laser beam so that an irradiation spot scans a surface of an irradiation object, and
a laser irradiation state diagnosis apparatus comprising:
an acoustic information acquisition unit for acquiring acoustic information in the vicinity of an irradiation spot when irradiating a laser beam so that the irradiation spot scans a surface of an irradiation object; and
a peeling state determining unit which determines a peeling state of adhered substances existing on a surface of the irradiation object based on characteristics of the sound information.

33. The laser irradiation apparatus according to claim 32, wherein
the irradiation head includes a driving unit that drives a moving optical system that changes an optical path of the laser beam, and
includes an abnormality determination unit that determines an abnormality of the driving unit based on the acoustic information.

34. The laser irradiation apparatus according to claim 32, wherein
the irradiation head includes a driving unit that drives a moving optical system that changes an optical path of the laser beam, and
a speed detection unit that detects a driving speed of the driving unit based on the acoustic information.

35. The laser irradiation apparatus according to claim 32,
further comprising a sound recognition unit which recognizes a specific sound having predetermined characteristics from the acoustic information, and
when the sound recognition unit recognizes the specific sound, the irradiation condition of the laser beam to be emitted is changed or the emission of the laser beam is stopped, and
wherein the specific sound is a sound generated by a sound generator disposed around an operator or outside of an irradiated area of an irradiation object.

36. (canceled)

37. The laser irradiation apparatus according to claim 32,
further comprising a sound recognition unit which recognizes a specific sound having predetermined characteristics from the acoustic information, and
when the sound recognition unit recognizes the specific sound, the irradiation condition of the laser beam to be emitted is changed or the emission of the laser beam is stopped,
and wherein the specific sound is a voice of an operator.

38. (canceled)

39. A laser irradiation state diagnosis program which causes a computer including an acoustic information acquisition unit for acquiring acoustic information to execute the laser irradiation state diagnosis method of claim 11.

40. A laser irradiation state diagnosis apparatus according to claim 26, wherein the sound information acquisition unit includes a sound collection device provided in an irradiation head that emits the laser beam.

41. The laser irradiation state diagnosis apparatus according to claim 26, wherein the sound information acquisition unit includes a sound collection device that is disposed at a position spaced apart from the irradiation head.

42. The laser irradiation state diagnosis apparatus according to claim 26, wherein the sound information acquisition unit includes a sound collection device attached to the irradiation object.
